(19) United States
(12) Patent Application Publication
(10) Pub. No.: US 2003/0101118 A1
(43) Pub. Date: May 29, 2003

(54) Method and apparatus for facilitating revision of a process

(76) Inventors: Thomas E. Macken JR., Riverside, CT (US); Lesly Regis, Trumball, CT (US)

Correspondence Address: BUCKLEY, MASCHOFF, TALWALKAR, & ALLISON, 5 ELM STREET, NEW CANAAN, CT, 06840, US

(21) Appl. No.: 09/998,421

(22) Filed: Nov. 29, 2001

(51) Int. Cl. G06F 17/60

(52) U.S. Cl. 705/35

(57) ABSTRACT

A system, method, apparatus, means, and computer program code for revising a process and/or facilitating one or more revisions to a process. According to embodiments of the present invention, a process is identified or otherwise determined and analysis conducted on value added and core competencies associated with the process. From this, one or more revisions to the process can be identified and implemented.

### FIELD OF THE INVENTION

The present invention relates to a method and apparatus for revising a process and, more particularly, embodiments of the present invention relate to methods, means, apparatus, and computer program code for facilitating one or more revisions to a process.

### BACKGROUND OF THE INVENTION

Organizations, business units or groups, individuals, companies, etc. implement processes as part of routine and daily operation. Processes may be or include accounting functions, payment support services, consumer accounting, cash management, credit card servicing and settlement, account reconciliation, settlement functions, closing and other financial reporting, regulatory accounting, budget forecasting and analysis, customer service, client management, client communications, business development or integration, etc. For example, a company may have a group of people and/or devices (e.g., computers, database servers) that provide or conduct credit card payment and billing processes for merchants. Such processes may include sending bills to the customers, receiving payments from customers, providing payments to merchants, investigating or resolving disputes regarding bills, investigating credit card fraud, etc.

Unfortunately, many processes become inefficient, costly or otherwise ineffective over time. In addition, processes often require changes as a company's needs, customer base, expertise, products or organizational structure changes. It would be advantageous to provide a method and apparatus that facilitated the analysis and revision of a process.

### SUMMARY OF THE INVENTION

Embodiments of the present invention provide a system, method, apparatus, means, and computer program code for revising a process and/or facilitating one or more revisions to a process. According to embodiments of the present invention, a process is identified or otherwise determined and analysis is conducted on value added aspects and core competencies associated with the process. From this, one or more revisions to the process can be identified.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating revision of a process may include identifying a process for revision; determining an evaluation of the process; determining at least one core competency associated with the process; determining at least one value added aspect of the process; and determining at least one desired revision to the process based, at least in part, on the evaluation, the at least one core competency, and the at least one value added aspect. In another embodiment, a method for facilitating revision to a process may include identifying a process for revision; determining an EFT score associated with the process; determining an EFT score of at least one value added aspect of the process; and determining at least one desired revision to the process based, at least in part, on the EFT score associated with the process and the EFT score associated with the at least one value added aspect of the process.

According to embodiments of the present invention, a system for facilitating revision of a process may include a memory; a communication port; and a processor connected to the memory and the communication port, the processor being operative to identify a process for revision; determine an evaluation of the process; determine at least one core competency associated with the process; determine at least one value added aspect of the process; and determine at least one desired revision to the process based, at least in part, on the evaluation, the at least one core competency, and the at least one value added aspect. In another embodiment, a system for facilitating revision of a process may include a memory; a communication port; and a processor connected to the memory and the communication port, the processor being operative to identify a process for revision; determine an EFT score associated with the process; determine an EFT score of at least one value added aspect of the process; and determine at least one desired revision to the process based, at least in part, on the EFT score associated with the process and the EFT score associated with the at least one value added aspect of the process.

According to embodiments of the present invention, a computer program product in a computer readable medium for facilitating revision of a process may include first instructions for selecting a process for revision; second instructions for evaluating the process; third instructions for identifying at least one core competency associated with the process; fourth instructions for identifying at least one value added aspect of the process; and fifth instructions for identifying at least one desired revision to the process based, at least in part, on an evaluation of the process, the at least one core competency, and the at least one value added aspect. In another embodiment, a computer program product in a computer readable medium for facilitating revision of a process may include first instructions for selecting a process for revision; second instructions for generating an EFT score associated with the process; third instructions for generating an EFT score of at least one value added aspect of the process; and fourth instructions for generating at least one desired revision to the process based, at least in part, on the EFT score associated with the process and the EFT score associated with the at least one value added aspect of the process.

According to embodiments of the present invention, an apparatus for facilitating revision of a process may include means for selecting a process for revision; means for evaluating the process; means for identifying at least one core competency associated with the process; means for identifying at least one value added aspect of the process; and means for identifying at least one desired revision to the process based, at least in part, on an evaluation of the process, the at least one core competency, and the at least one value added aspect. In another embodiment, an apparatus for facilitating revision of a process may include means for selecting a process for revision; means for generating an EFT score associated with the process; means for generating an EFT score of at least one value added aspect of the process; and means for generating at least one desired revision to the process based, at least in part, on the EFT score associated with the process and the EFT score associated with the at least one value added aspect of the process.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of system components for an embodiment of an apparatus usable with the methods the present invention;

FIG. 2 is a block diagram of components for an embodiment of a server of FIG. 1; and

FIG. 3 is a flowchart of an embodiment of a method in accordance with the present invention, the method being usable with the system of FIG. 1.

### DETAILED DESCRIPTION

Applicants have recognized that there is a need for systems, means, computer programs and methods that facilitate revisions to processes. According to embodiments of the present invention, a process is identified or otherwise determined and analysis conducted on value added aspects and core competencies associated with the process. From this, one or more desired or needed revisions to the process can be identified. In some embodiments, a revision to a process may include automating, changing, outsourcing, revising, or removing aspects of the process that involve manual data entry or processing and/or reworking of previously conducted tasks. These and other features will be discussed in further detail below, by describing a system, individual devices, and processes according to embodiments of the invention.

System

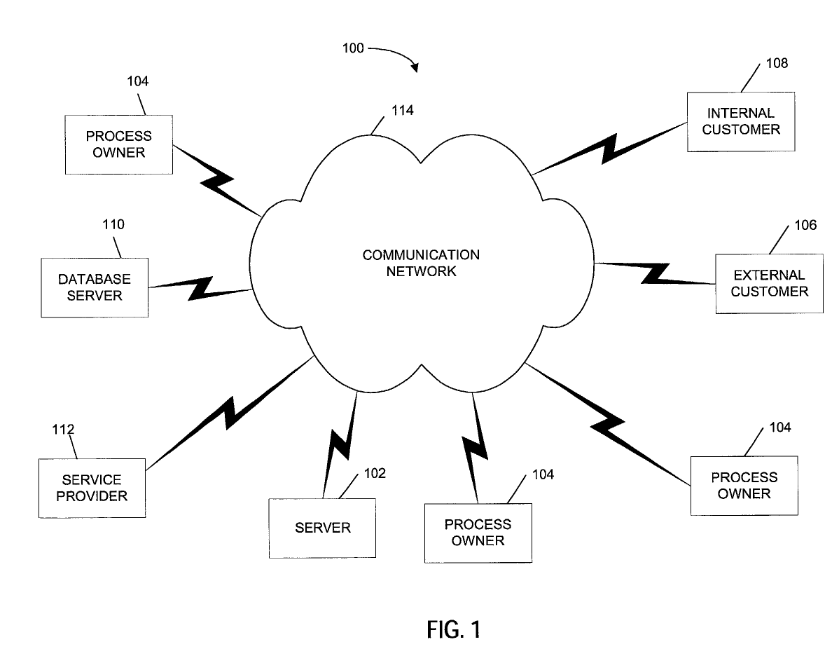

Now referring to FIG. 1, an apparatus or system 100 usable with the methods disclosed herein is illustrated. The system 100 includes a server or other device 102 that may communicate with a variety of process owners or users 104, external customers 106, internal customers 108, database servers or devices 110, and/or service providers 112 via a computer, data or other communications network 114. For purposes of further explanation and elaboration of the methods disclosed herein, the methods disclosed herein will be assumed to be operating on, or under the control of, one the servers 102. In some embodiments, however, the methods disclosed herein may be implemented by a process owner 104 or another entity or device.

A server 102 may implement or host a Web site. A server 102 may comprise a single device or computer, a networked set or group of devices or computers, a workstation, etc. In some embodiments, a server 102 also may function as a database server and/or assume some or all of the functions of the database server 110. The use, configuration and operation of the server 102 will be discussed in more detail below.

In some embodiments, a server 102 may be or include an expert or rules based system or model to implement the methods disclosed herein. In such embodiments, the server 102 may include or use algorithms, formulas, metrics, methodologies, conventions, systems, process criterion or requirements, models, heuristics, rules, etc. to monitor, evaluate, conduct, and revise processes, as will be discussed in more detail below. An expert or rules based system or model may access, include or use a knowledge base of human generated or captured expertise for the problem solving, determinations and computations involved or needed in the methods described herein. Often, such a system or model will be based on rules, data, mathematical representations, etc that are used for analysis and planning and processed via an inference/feedback engine or other software using a variety of techniques to obtain one or more results. As more knowledge is gained from customers, process owners, service providers, company representatives, etc., the data, rules, mathematical representations, etc. used by an expert system or model can be updated, enhanced, revised, etc. In some embodiments, the server 102 may include or access a computer program that simulates or models the judgment, expertise and behavior of a human or an organization and that has expert knowledge and experience in a particular field or a particular process. The computer software may contain or access a knowledge base containing accumulated experience and a set of rules for applying the knowledge base to each particular process or process revision situation that is described or inputted to the program.

In some embodiments, the server 102 may be involved in the analysis and revision of processes managed or performed by the process owners 104. The process owners 104 may be or include humans and/or electronic devices (e.g., a server or other computer). Typically, a process owner 104 will be responsible for managing, operating, or improving one or more processes involved or used in a business. Processes implemented by the process owners 104 may include accounting functions, payment support services, consumer accounting, cash management, credit card servicing and settlement, account reconciliation, settlement functions, closing and other financial reporting, regulatory accounting, budget forecasting and analysis, customer service, client management, client communications, business development or integration, etc. For example, a company may have a group of people and/or devices (e.g., computers, database servers) that provide credit card payment and billing functions for merchants (i.e., a type of external customer 106) and that act as the middle link between the merchants and the merchants' customers for processing credit card transactions on behalf of the merchants and customers. Such processing may include sending bills to the customers, receiving payments from customers, providing payments to merchants, investigating or resolving disputes regarding bills or charges, investigating credit card fraud, etc.

Process owners 104 for a company may conduct processes for the internal customers 108, which may be internal business units of the company, or the external customers 106, which may be users or purchases of the company's products or services. Process owners 104 may use or interact with the database servers 110 to receive, store and update information regarding processes, products, services, customers, reports, analytical tools, etc. The process owners 104 and/or the server 102 may interact with one or more vendors or service providers 112 as part of conducting, analyzing, or revising a process.

The devices or entities shown in FIG. 1 need not be in constant communication. For example, the server 102 may communicate with a process owner 104 only when such communication is appropriate or necessary.

Many different types of implementations or hardware configurations can be used in the system 100 and with the methods disclosed herein and the methods disclosed herein are not limited to any specific hardware configuration for the system 100 or any of its components.

The communications network 114 might be or include the Internet, the World Wide Web, or some other public or private computer, cable, telephone, client/server, peer-to-peer, or communications network or intranet, as will be described in further detail below. The communications network 114 illustrated in FIG. 1 is meant only to be generally representative of cable, data, radio, computer, telephone, peer-to-peer or other communication networks for purposes of elaboration and explanation of the present invention and other devices, networks, etc. may be connected to the communications network 206 without departing from the scope of the present invention. The communications network 206 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Server

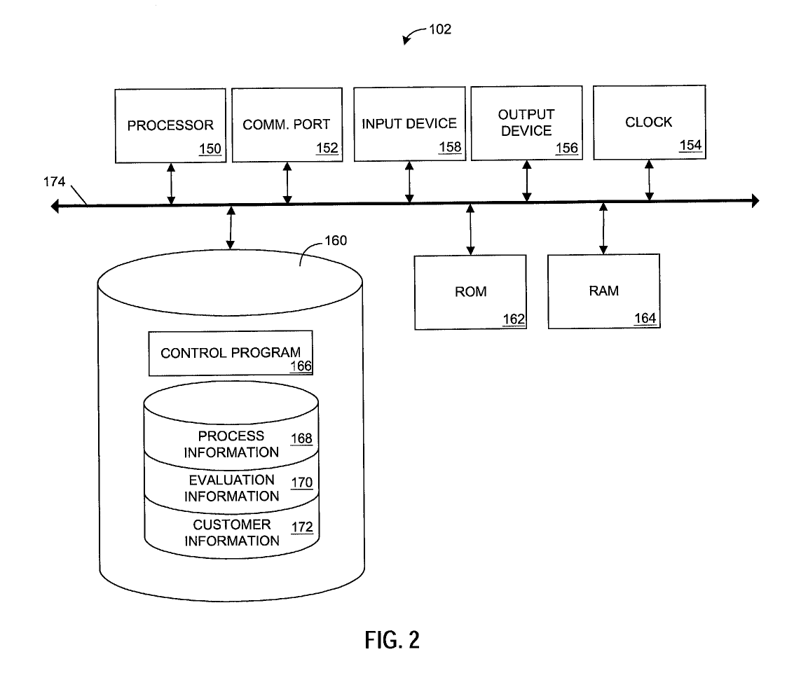

Now referring to FIG. 2, a representative block diagram of a server or controller 102 is illustrated. As previously discussed above, the server 102 can comprise a single device or computer, a networked set or group of devices or computers, a workstation, etc. In some embodiments, a server 102 also may function as a database server and/or assume some or all of the functions of the database server 110. The server 102 may be or include an expert or rules based system, as previously discussed above. In such embodiments, server 102 may include or use algorithms, formulas, metrics, methodologies, conventions, systems, process criterion or requirements, models, heuristics, rules, etc. to monitor, evaluate, conduct, and revise processes.

The server 102 may include a processor, microchip, central processing unit, or computer 150 that is in communication with or otherwise uses or includes one or more communication ports 152 for communicating with user devices and/or other devices. Communication ports may include such things as local area network adapters, wireless communication devices, Bluetooth technology, etc. The server 102 also may include an internal clock element 154 to maintain an accurate time and date for the server 102, create time stamps for communications received or sent by the server 102, etc.

If desired, the server 102 may include one or more output devices 156 such as a printer, infrared or other transmitter, antenna, audio speaker, display screen or monitor, text to speech converter, etc., as well as one or more input devices 158 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 102 may include a memory or data storage device 160 to store information, software, databases, communications, device drivers, rules, models, scoring techniques, processes, etc. The memory or data storage device 160 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 102 also may include separate ROM 162 and RAM 164.

The processor 150 and the data storage device 160 in the server 102 each may be, for example: (i) located entirely within a single computer or other computing device; or (ii) connected to each other by a remote communication medium, such as a serial port cable, telephone line or radio frequency transceiver. In one embodiment, the server 102 may comprise one or more computers that are connected to a remote server computer for maintaining databases.

A conventional personal computer or workstation with sufficient memory and processing capability may be used as the server 102. In one embodiment, the server 102 operates as or includes a Web server for an Internet environment. The server 102 preferably is capable of high volume transaction processing, performing a significant number of mathematical calculations in processing communications and database searches. A Pentium™ microprocessor such as the Pentium III™ or IV™ microprocessor, manufactured by Intel Corporation may be used for the processor 150. Equivalent processors are available from Motorola, Inc., AMD, or Sun Microsystems, Inc. The processor 150 also may comprise one or more microprocessors, computers, computer systems, etc.

Software may be resident and operating or operational on the server 102. The software may be stored on the data storage device 160 and may include a control program 166 for operating the server, databases, etc. The control program 166 may control the processor 150. The processor 150 preferably performs instructions of the control program 166, and thereby operates in accordance with the present invention, and particularly in accordance with the methods described in detail herein. The control program 166 may be stored in a compressed, uncompiled and/or encrypted format. The control program 166 furthermore includes program elements that may be necessary, such as an operating system, a database management system and device drivers for allowing the processor 150 to interface with peripheral devices, databases, etc. Appropriate program elements are known to those skilled in the art, and need not be described in detail herein.

The server 102 also may include or store information regarding processes, evaluation criteria, customer information, communications, rules, heuristics, algorithms, formulas, etc. For example, information regarding one or more processes may be stored in a process information database 168 for use by the server 102 or another device or entity. Information regarding one or more evaluation metrics may be stored in an evaluation information database 170 for use by the server 102 or another device or entity and information regarding one or more customers may be stored in a customer information database 172 for use by the server 102 or another device or entity. Similarly, the server 102 may include or access databases for storing information regarding service providers. The server 102 also may include rules, models, etc. needed when the server 102 implements the methods disclosed herein as an expert or rules based system. In some embodiments, some or all of one or more of the databases may be stored or mirrored remotely from the server 102, such as on one or more of the database servers 110.

According to an embodiment of the present invention, the instructions of the control program may be read into a main memory from another computer-readable medium, such as from the ROM 162 to the RAM 164. Execution of sequences of the instructions in the control program causes the processor 150 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 150, communication port 152, clock 154, output device 156, input device 158, data storage device 160, ROM 162, and RAM 164 may communicate or be connected directly or indirectly in a variety of ways. For example, the processor 150, communication port 152, clock 154, output device 156, input device 158, data storage device 160, ROM 162, and RAM 164 may be connected via a bus 174.

While specific implementations and hardware configurations for server 102 have been illustrated, it should be noted that other implementations and hardware configurations are possible and that no specific implementation or hardware configuration is needed. Thus, not all of the components illustrated in FIG. 2 may be needed for a server or process owner implementing the methods disclosed herein. Therefore, many different types of implementations or hardware configurations can be used in the system 100 and the methods disclosed herein are not limited to any specific hardware configuration. In some embodiments, devices used for a process owner 104, an external customer 106, an internal customer 108, a service provider 112, and/or a database serve 110 may have or include some or all of the components illustrated in FIG. 2.

Method Description

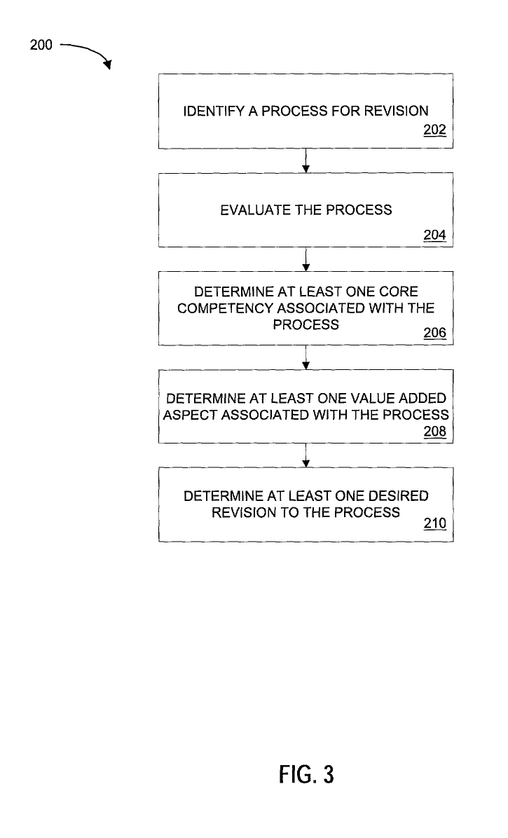

Reference is now made to FIG. 3, where a flow chart 200 is shown which represents the operation of a first embodiment of the present invention. The method 200 may be implemented by the server 102 or by a process owner 104. The particular arrangement of elements in the flow chart 200 is not meant to imply a fixed order to the steps; embodiments of the present invention can be practiced in any order that is practicable. In some embodiments, some or all of the steps of the method 200 may be performed or completed by the server 102 and/or another entity or device. For purposes of the following discussion, the method 200 will be assumed to be conducted by the server 102. One technical effect of the method 200 is that the method 200 may help quantify or identify aspects of a process suitable for revision, thereby reducing labor, communication, data processing, and capital costs and time associated with the process and making the process more efficient.

Processing begins at a step 202 during which a process for revision is identified. A process for revision may be identified as a result of a request received by the server 102 from a process owner 104, customer, service provider, etc. to revise a process. The request may be included in or form part of an email message, instant message communication, XML feed, or other electronic signal or communication. For example, the server 102 may receive a request in an email message from a customer to change the ways bills are generated and sent to the customer. As another example, a process owner 104 may determine that a billing process involves numerous employees, computer processing time, and requires a large amount of communication between or information from employees, customers, and/or electronic resources (e.g., databases) to generate a bill, even if the process is already completely automated. The process owner 104 may want to streamline the process for generating bills to reduce the labor and time required to generate bills.

As another example, a company's annual reports, accounting, etc. may reveal the costs and benefits associated with certain functions or other processes conducted by the company. A process may be determined during the step 202 by selecting a process for revision that generates a high cost and/or low return. Such costs may be measured in labor costs, capital costs, etc.

In some embodiments, the step 202 may be or include one or more of the following: receiving a request to revise the process; determining costs associated with a plurality of processes and selecting the process from the plurality that has the highest associated cost; determining revenues associated with a plurality of processes and selecting the process from the plurality of process that has the lowest associated revenue; determining a cost associated with at least one process; determining revenue associated with at least one process; determining at least one transaction processing function associated with a specific business need; determining at least one business integration function associated with a specific business need; determining at least one accounting function associated with a specific business need; determining at least one reporting function associated with a specific business need; etc.

During a step 204, the process identified during the step 202 is evaluated to determine performance or implementation criteria by which revisions to the process can be compared. In some embodiments, the step 204 may be included in, or be part of, the step 202 and used to select a process for revision. A process evaluation may document and analyze the development and actual implementation of the process. In addition, the evaluation may assess if components of the process were implemented as planned and whether expected output of the process was actually produced. In some process evaluation techniques, a key element in the analysis is a systematic plan for collecting data to determine whatever the process being implemented as specified and, if not, how operations differ from those initially planned, determine unintended or unanticipated results of a process, and better understand the process from the perspectives of the process owners 104 and relevant customers, service providers or other parties. In some embodiments, the step 204 may include documenting, receiving, determining or measuring customer requirements and compliance of a process with the requirements, evaluating implementation of the process in contrast with visions, objectives, requirements, or goals associated with the process, measuring quality of the services or products produced by or resulting from a process, collecting or receiving data generated by the process and comparing it to data expected to be generated by the process, assessing controls and effectiveness or efficiency of the controls associated with a process, building or accessing a model of the process and comparing actual results of the process with theoretically possible results from the process, developing or receiving at least one desired goal, objective, mission, etc. for a process and measuring performance or output of the process against such goal, objective or mission, establish a desired control plan for a process and monitor compliance of an implementation of the process with the desired control plan, etc.

As one example of the step 204, a process may be evaluated to determine its effective full time (EFT) person score. A process having a higher EFT score than a second process may require more people, require more steps, take longer to complete, etc. than the second process. In some embodiments, determining an EFT score for a process or a portion of a process may include determining how many people are involved in or with a process. For example, an EFT score of fifty for a cash accounting process implies that fifty full time employees or full time equivalents (e.g., two part time employees may equal one full time equivalent employee) are involved in or with the cash accounting process. In some cases, there may be functions of a process that are not been conducted or completed. Thus, evaluation of the process during the step 204 may result in an EFT score that reflects that additional people are needed to complete the process than are currently assigned to the process or working in or with the process. For example, if there are aspects of the cash accounting process mentioned above that are not being conducted and that require two full time employees or two full time equivalent employees to perform, the EFT score for the cash accounting process may be fifty-two instead of fifty.

In some embodiments, the server 102 may comprise or access and expert or rules based system or model to determine EFT scores for a processes or aspects of the process. In other embodiments, the server may receive EFT scores from other parties (e.g., customers, service providers, company employees or representatives) or devices.

Process evaluation may result in a qualitative and/or quantitative score that can be associated with the process. Quality evaluations, scoring criterion, statistical analysis, accounting analysis, and other techniques may be used to evaluate the process identified during the step 202. Many evaluation techniques for processes are well known in the art and need not be described further herein for purposes of explanation of the present invention.

In some embodiments, information regarding process evaluations or the results of the evaluations may be stored or found in the server 102, a process owner 104, a database server 110 or some other party or device. In some embodiments the step 204 may be or include determining an EFT score associated with the process identified during the step 202. In some embodiments, the server 102, a process owner 104, a customer, a service provider or other party or entity may generate a rank or score regarding a process. The server 102 may receive such ranking or scoring information as part of, or during, the step 204.

In some embodiments, the step 204 may include generating, sending or receiving data indicative of an EFT score associated with a process. Data may be sent or received in or as part of an email message; instant message communication; HTML, HTTP or XML transmission or feed; radio signal transmission, or other electronic communication or signal.

During an optional step 206, at least one core competency associated with process identified in the step 202 is determined. In general, a core competency is fundamental knowledge, ability, background or expertise in a specific subject area or skill set. A company with expertise and strengths in one or more specific areas, such as data recovery, transaction processing, information processing, capital planning, business acquisition and integration, computer program development, Web site development or hosting, computer network integration, etc., can be said to have a core competency in those areas.

The analysis of a company's or other entity's core competency or competencies may take many different forms and formats. For example, knowledge management analysis tools and techniques exist to monitor, evaluate and score a company's workflow and information processing skills. As another example, the Clinger-Cohen core competencies serve as a baseline to assist a government agency to complying with the Clinger-Cohen act. Analysis and scoring in accordance with these competencies provide insight in the agency's compliance.

As another example, the server 102, a process owner 104, a customer, a service provider, consultant, or other party or device may rank or score a company's, individual's or business units core competencies. The server 102 may receive such ranking or scoring information as part of or during the step 206.

In some embodiments, the server 102 may determine which processes or aspects of a customer or company's business involve transaction processing, remittance processing, account reconciliation, data entry, accounting, report generation, etc. that are ancillary to a customer or company's core business. As these functions may be ancillary to the company's primary business functions, such functions may be considered as not being part of the company's core competencies. Areas or functions considered core competencies may be performed within or locally to the company while other areas or functions may be outsourced or offloaded to service providers, other business units, etc. Additional information regarding the recognition, management, and offloading of components of processes may be found in the provisional patent application entitled “Work Transition Template”, filed Sep. 18, 2001, and having Application Serial No. 60/323,066 and the pending patent application entitled “Systems and Methods to Facilitate Migration of a Process via a Process Migration Template” filed simultaneously herewith, the contents of all of both of which are incorporated herein by reference.

In some embodiments, quantitative analysis of core competencies may be performed by prorating or apportioning an EFT score associated with a process among different areas or functions evaluated as core competencies or evaluated to not be core competencies. For example, a process evaluated during the step 204 may have an EFT score of sixty. During the step 206, it may be determined that eighty percent of the EFT score of sixty involve core competencies of an individual, company, business group, etc. implementing or conducting the process. Thus, the areas or functions of the process involving core competencies involve an EFT score of forty-eight of the total EFT score of sixty associated with the process.

During a step 208, at least one value added aspect is determined for the process identified during the step 202. In some embodiments, the step 208 may be implemented by determining what portions of the process involve manual entry of data and by determining what portions of the process involve reworking of previously performed tasks associated with the process. For example, suppose a cash management process is identified during the step 202. A cash management process for an organization may involve cash disbursement and cash accounting. A manual aspect or portion of the cash management process may include research regarding returned checks or checks having non-sufficient funds. A rework aspect or portion of the cash management process may include clearing suspended payments, clearing payments not properly credited to an account, etc.

Once the rework and manual portions of a process are determined, evaluations of the rework and manual portions of a process to generate EFT scores for the portions can then be created. The relative EFT scores for these portions of the process can be compared against the EFT score for the entire process that may be determined during the step 204. As a result, a weighting of these portions to the overall EFT score can be ascertained, thereby producing a score indicative of the relative impacts of these portions on the overall process. The remainder of the EFT determined during the step 204 can be considered as value added functions for the process, since they do not involve manual entry of data or rework of previously conducted tasks. In some embodiments, the server 102, a process owner 104, a customer, a service provider or other party or entity may generate the EFT score for the manual or rework portions of a process. The server 102 may receive such EFT scoring information as part of or during the step 208.

In some embodiments, the server 102 may receive EFT scores or other rankings from customers, service providers or other parties or devices. Such EFT scores or other rankings received from other parties or devices may involve or encompass entire processes or only portions of the processes. As previously mentioned above, in some embodiments, the server 102 may comprise or access an expert or rules based system or model to determine EFT scores for processes or manual, rework or other aspects of the processes.

In some embodiments, the step 208 may include generating, sending or receiving data indicative of an EFT score associated with a rework portion of said process and/or generating, sending or receiving data indicative of an EFT score associated with a manual portion of said process. Data may be sent or received in or as part of an email message; instant message communication; HTML, HTTP or XML transmission or feed; radio signal transmission, or other electronic communication or signal.

During a step 210, the process identified during the step 202 is revised based, at least in part, on the determinations made during the steps 204, 206 and 208. In some embodiments, goals (e.g., performance or productivity goals, revenue generation goals, employee or EFT reduction goals) may be established prior to the step 202 or the step 210 to provide guidance to the step 210. In some embodiments, the server 102 may comprise or access and expert or rules based system or model to implement the step 210.

As one example of the step 210, suppose a cash management process is selected during the step 202. During the step 204, and evaluation of the cash management process results in a determination of an EFT score of 75.0 for the process. An EFT score of 75.0 for the cash management process indicates that seventy-five full time equivalent people are involved in or associated with the cash management process. During the step 206, it may be determined that cash collection, cash disbursement, transaction recording, and accounting are core competencies associated with the cash management process while account reconciliations and remittance processing are not. During the step 208, it may be determined that rework portions of the cash management process comprise 30.4 of the overall 75.0 EFT score for the process while manual portions of the cash management process may comprise 21.3 of the overall 75.0 EFT score for the process. Thus, the value added portions of the cash management process comprises 23.3 (i.e., 75.0−30.4−21.3=23.3) of the overall 75.0 EFT score for the process. Stated in another way, over half of the EFT score of 75.0 associated with the process is not associated with the value added aspects of the process. Thus, reducing the EFT scores associated with the manual and rework portions of the process will reduce the overall EFT score associated with process improve the relative percentage of the overall EFT associated with the value added aspects of the process. In some cases, the higher the EFT score associated with a process or a portion of a process, the greater opportunity available to revise the process or the portion of the process to reduce the overall EFT score.

During the step 210, the relative weights of the EFT scores determined during the steps 204 and 208 as guided by the core competencies determined during the step 208 may indicate that revisions to the cash management process that reduce, simplify, outsource, migrate, automate or even eliminate the manual and/or rework aspects of the cash management process will improve the value added aspects of the cash management process (or the relative percentage of the EFT score of the value added aspects to the overall EFT score) and reduce the overall EFT score associated with the cash management process. An area or portion of a process having a relatively high EFT score may be a prime target for revision.

Improvements in the manual aspects of the cash management process may be or include an automation of a cash accounting task or function to reduce human involvement or participating in the task or function. Improvements in the rework aspects of the cash management process may be or include reducing the occurrence or likelihood of improperly applied or non-applied payments that may result from keypunch errors, inaccurate scanning or reading of checks or other documents during processing, etc. Revisions to the process may include changing how checks are scanned to reduce errors in scanning, adding automated checks for accuracy of scans, etc.

In some embodiments, determining at least one desired revision to the process based, at least in part, on the evaluation, the at least one core competency, and the at least one value added aspect may include identifying at least one area of the process that can be revised to reduce rework associated with the area and/or identifying at least one area of the process that can be revised to reduce manual entry of data associated with the area.

In some embodiments, the method 200 may include a step after the step 210 where evaluations of a revised process or one or more portions of the revised process are conducted or implemented. For example, EFT scores of the revised process or one or more portions of the revised process may be determined to evaluate performance or improvement in the process identified during the step 202.

In some embodiments, a party or device implementing the method 200 may revise the process identified during the step 202 in accordance with the at least one desired revision determined during the step 210, implement a revised version of the process identified during the step 202, the revised version created in accordance with the at least one desired revision identified during the step 210, determine an evaluation of a revised version of a process, etc.

In another embodiment of a method in accordance with the present invention, a method for facilitating revision to a process may include identifying a process for revision as previously discussed above; determining an EFT score associated with the process as previously discussed above; determining an EFT score of at least one value added aspect of the process as previously discussed above; and determining at least one desired revision to the process based, at least in part, on the EFT score associated with the process and the EFT score associated with the at least one value added aspect of the process as previously discussed above. In some embodiments, the method also may include determining at least one core competency associated with the identified process. The method may be implemented by the server 102, a process owner 104 or other entity or device. In some embodiments, a device implementing the method may use or comprise an expert or rules based system or model.

In some embodiments, determining an EFT score of at least one value added aspect of the process may include identifying the value added aspect of the process, determining a manual aspect and/or a rework aspect of the process, determining an EFT score associated with the manual aspect and/or the rework aspect of the process, identifying at least one manual aspect of the process, identifying at least one rework aspect of the process, generating, sending or receiving data indicative of an EFT score associated with a process, etc.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating revision of a process, comprising:
identifying a process for revision;
determining an evaluation of said process;
determining at least one core competency associated with said process;
determining at least one value added aspect of said process; and
determining at least one desired revision to said process based, at least in part, on said evaluation, said at least one core competency, and said at least one value added aspect.

2. The method of claim 1, wherein said identifying a process includes at least one of the following:
receiving a request to revise said process;
determining costs associated with a plurality of processes and selecting the process from the plurality that has the highest associated cost;
determining revenues associated with a plurality of processes and selecting the process from the plurality of process that has the lowest associated revenue;
determining a cost associated with at least one process;
determining revenue associated with at least one process;
determining at least one transaction processing function associated with a specific business need;
determining at least one business integration function associated with a specific business need;
determining at least one accounting function associated with a specific business need; and
determining at least one reporting function associated with a specific business need.

3. The method of claim 1, wherein said determining an evaluation of said process includes determining an EFT score associated with said process.

4. The method of claim 1, wherein said determining an evaluation of said process includes receiving data indicative of an EFT score associated with said process.

5. The method of claim 1, wherein said determining at least one core competency associated with said process includes at least one of the following:
identifying at least one area of said process involving transaction processing of data; and
identifying at least one area of said process involving reconciliation of an account.

6. The method of claim 1, wherein said determining at least one value added aspect of said process includes at least one of the following:
receiving data indicative of an EFT score associated with a rework portion of said process;
receiving data indicative of an EFT score associated with a manual portion of said process;
identifying at least one area of said process involving rework; and
identifying at least one area of said process involving manual entry of data.

7. The method of claim 1, wherein said determining at least one desired revision to said process based, at least in part, on said evaluation, said at least one core competency, and said at least one value added aspect includes at least one of the following:
identifying at least one revision to said process that will reduce an EFT score associated with said process;
identifying at least one area of said process that can be revised to reduce rework associated with said area; and
identifying at least one area of said process that can be revised to reduce manual entry of data associated with said area.

8. The method of claim 1, further comprising:
revising said process in accordance with said at least one desired revision.

9. The method of claim 1, further comprising:
implementing a revised version of said process, said revised version created in accordance with said at least one desired revision.

10. The method of claim 1, further comprising:
determining an evaluation of a revised version of said process.

11. A method for facilitating revision to a process, comprising:
identifying a process for revision;
determining an EFT score associated with said process;
determining an EFT score of at least one value added aspect of said process; and
determining at least one desired revision to said process based, at least in part, on said EFT score associated with said process and said EFT score associated with said at least one value added aspect of said process.

12. The method of claim 11, wherein said determining an EFT score of at least one value added aspect of said process includes determining a manual aspect of said process and determining an EFT score associated with said manual aspect of said process.

13. The method of claim 11, wherein said determining an EFT score of at least one value added aspect of said process includes determining a rework aspect of said process and determining an EFT score associated with said rework aspect of said process.

14. The method of claim 11, further comprising:
identifying said value added aspect of said process.

15. The method of claim 14, further comprising:
identifying at least one manual aspect of said process.

16. The method of claim 15, further comprising:
determining an EFT score associated with said manual aspect of said process.

17. The method of claim 14, further comprising:
identifying at least one rework aspect of said process.

18. The method of claim 17, further comprising:
determining an EFT score associated with said rework aspect of said process.

19. The method of claim 11, further comprising:
determining at least one core competency associated with said process.

20. The method of claim 11, wherein said determining an EFT score associated with said process includes receiving data indicative of said EFT score associated with said process.

210. The method of claim 11, wherein said determining an EFT score of at least one value added aspect of said process includes receiving data indicative of said EFT score associated with said process.

22. A system for facilitating revision of a process, comprising:
a memory;
a communication port; and
a processor connected to said memory and said communication port, said processor being operative to:
identify a process for revision;
determine an evaluation of said process;
determine at least one core competency associated with said process;
determine at least one value added aspect of said process; and
determine at least one desired revision to said process based, at least in part, on said evaluation, said at least one core competency, and said at least one value added aspect.

23. A computer program product in a computer readable medium for facilitating revision of a process, comprising:
first instructions for selecting a process for revision;
second instructions for evaluating said process;
third instructions for identifying at least one core competency associated with said process;
fourth instructions for identifying at least one value added aspect of said process; and
fifth instructions for identifying at least one desired revision to said process based, at least in part, on an evaluation of said process, said at least one core competency, and said at least one value added aspect.
